(19) United States
(12) Patent Application Publication
(10) Pub. No.: US 2021/0090093 A1
(43) Pub. Date: Mar. 25, 2021

(54) COMPUTER-ENABLED PLATFORM FOR DELIVERING PRODUCTS TAMPER-PROOF

(71) Applicant: Paul LARGOZA, Kingston, MA (US)

(72) Inventor: Paul LARGOZA, Kingston, MA (US)

(21) Appl. No.: 17/026,902

(22) Filed: Sep. 21, 2020

Related U.S. Application Data
(60) Provisional application No. 62/903,475, filed on Sep. 20, 2019.

(51) Int. Cl. G06Q 30/00; G06Q 30/06; G06Q 10/08; G06Q 10/10; G06K 19/06

(52) U.S. Cl. CPC G06Q 30/0185; G06Q 30/0635; G06K 19/06037; G06Q 10/107; G06Q 10/0832

(57) ABSTRACT

The computer-enabled tamper-proof product packaging system and method operates in the context of customers ordering a product for delivery from a product delivery system, wherein the products may be perishable The tamper-proof product packaging system establishes a platform that includes processes and procedures for securing product orders from tampering by training products delivery systems in these processes and procedures and requiring product delivery systems to use tamper-proof labels with a unique identifier than is permanently marked thereon, or on securely affixed, or on a tagged with the package. The tamper-proof labels sealed packaging ensures that the product is not tampered with between leaving the product source and being delivered to the customer.

### TECHNICAL FIELD

Embodiments of the disclosure relate generally to the field of transporting and monitoring goods during transition from a sender to a receiver. Embodiments relate more particularly to a method and system for securing and verifying delivered items during a delivery transition.

### BACKGROUND

Package delivery or parcel delivery is the delivery of shipping containers or parcels from a source location to a destination location. The service is provided by several postal systems, mails and courier companies. A common obstacle of package delivery is tampering. Tampering is the deliberate altering of the package and/or the goods. In other words, tampering means altering, damaging or misusing goods that are delivered to customers.

The only response to tampering is staples, tapes and stickers. Staples can be removed and easily removed such that there is no indication of tampering. Additionally, staples are common and easily available. Tapes may be easily removed and applied later after the package contents have been accessed. Stickers may be replaced with another sticker after the package contents have been accessed.

It is desirable to fabricate containers that include features that identify whether tampering has occurred or not. This should enable the customer to visually recognize tampering so that the product is rejected.

In light of the above discussion, there appears to be a need for a method and system to secure and verify delivered items during delivery transition.

### OBJECT OF INVENTION

The principal object of the embodiments herein is to secure and verify that delivered food and items have not been tampered during delivery between a sender and a receiver.

Another object of the embodiments herein is to track, monitor and deter tampering by a delivery service (deliverer).

### SUMMARY

The above-mentioned needs are met by a computer-implemented method and system for securing and verifying delivered items during delivery transition between a sender and a customer.

The computer-enabled tamper-proof product packaging system and method operates in the context of customers ordering a product for delivery from a product delivery system, wherein the products may be perishable (likely to decay or go bad quickly) or non-perishable (items that have a longer shelf life). Examples of the product includes, but are not limited to food, clothing, medicines, stationery and the like. The tamper-proof product packaging system establishes a platform that includes processes and procedures for securing product orders from tampering by training products delivery systems in these processes and procedures and requiring product delivery systems to use tamper-proof labels with a unique identifier that is marked thereon, or securely affixed, or tagged with the package. The tamper-proof labels and sealed packaging ensure that the product is not tampered with between leaving the product source and being delivered to the customer.

The product delivery system maintains an inventory of unique identifiers of the labels that have been assigned or provided to a product by the tamper-proof product packaging system, which maintains a digital database of all of the unique identifiers that have been assigned to the scanned tamper-proof labels. The tamper-proof product packaging system operates and controls one or more servers which maintain the digital database and a processor on the server operates according to a set of instructions to automatically administer over the computer-enabled web-based platform, method and system. The tamper-proof product packaging system creates and provides a user interface that is loaded onto a product delivery's computing device to receive one or more user inputs related to a product order. When the product delivery system receives a product order for delivery, the product delivery system prepares and packages the product according to the process established by the tamper-proof product packaging system. For example, a food source receives a food order, food source prepares the food order and packages using the tamper-proof labels which entails sealing the food order in tamper-proof packaging.

The tamper-proof label is generated with a unique identifier that is then associated with the product order. With the product sealed inside the tamper proof packaging, the product delivery system uses the user interface provided by the tamper-proof product delivering system to scan and upload tamper-proof label attached to the package of the product. The unique identifier of the tamper-proof label can be in the form of a code comprising letters, number and/or keyboard symbols, a bar code, a QR Code, or another machine readable code, and the unique identifier can be entered into the product delivery computing device by scanning, photographic capture, or manually entered through a computer keyboard that can be mechanical or electronic.

The product delivery system user interface communicates the tamper-proof label details to the tamper-proof product packaging server and the processor is programmed to store the uploaded tamper-proof label in the digital database. The processor communicates to the product delivery system user interface that the tamper-proof label details are stored and the package is ready for deployment and is now associated with the product order inside the sealed package.

According to an embodiment, the tamper-proof product delivering system transmits the tamper-proof label details associated with the package to the customer through the customer user interface provided by a mobile or web-based applications installed and accessible on the customer computing device. This can be done automatically if the customer has a customer profile saved with the tamper-proof product packaging system so that the customer's identity is known and verified. In another embodiment, the customer can communicate with the one or more servers to retrieve the unique identifier of the tamper-proof label by providing information about the product order, or a verification code automatically given to the customer by the product delivery system when the customer ordered the product. In other embodiments, the tamper-proof product packaging system automatically sends the unique identifier directly to the customer, for example by a text notification, e-mail, phone call or other notification method chosen by the customer. With these embodiments the customer can immediately validate that the product has been delivered correctly and securely.

When the product is delivered to the customer, the customer inspects the sealed package to be sure that it has not been tampered with. If there are no visible signs of damage to the packaging or the tamper proof seal device then the customer accepts the package access the customer user interface by operating the customer computing device provided by the tamper-proof product delivering system that enables the customer to communicate with the the tamper-proof product delivering system using a communication network such as the internet. The one or more processors that are part of the tamper-proof product packaging system one or more servers receiving the unique identifier of the tamper-proof label reported by the customer, which was entered into the customer's computer using the customer's user interface, for example, by using photographic scanning or manual keyboard entry. The processor compares the unique identifier with the unique identifier uploaded by the product delivery system and marked by the processor in the digital database as being deployed for the customer's order. If the unique identifiers match, then the processor automatically provides a confirmation to the tamper-proof product packaging system that the product was delivered securely, and the processor marks the status of the unique identifier in the digital database accordingly.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE VIEWS OF DRAWINGS

In the accompanying figures, similar reference numerals may refer to identical or functionally similar elements. These reference numerals are used in the detailed description to illustrate various embodiments and to explain various aspects and advantages of the present disclosure.

FIG. 1 is an illustration of an environment, where at least some example embodiments can be practiced;

FIG. 2 is a flow diagram illustrating the process of the method described herein, according to the embodiments as disclosed herein;

FIG. 3 is a flow diagram illustrating a method to secure and verify delivered items during delivery transition, according to the embodiments as disclosed herein;

FIG. 4 is a schematic representation illustrating the dimensions and scale of a tamper-proof label, according to the embodiments as disclosed herein;

FIG. 5 is a schematic representation of the tamper-proof label for a drink saver, according to the embodiments as disclosed herein;

FIGS. 6a and 6b is a sequence diagram illustrating the transition of a package delivery between the product delivery system and the customer, according to the embodiments as disclosed herein;

FIG. 7 is a pictorial representation of the tamper-proof label for a default brand, according to the embodiments as disclosed herein;

FIG. 8a, FIG. 8b and FIG. 8c are pictorial representations of the tamper-proof label for exemplary brands, according to the embodiments as disclosed herein;

FIG. 9a and FIG. 9b are pictorial representations of the tamper-proof label with a logo mark, according to the embodiments as disclosed herein;

FIG. 10 schematic illustrations of the tamper-proof label for drink savers, according to the embodiments as disclosed herein;

FIG. 11a and FIG. 11b are exemplary representations of the tamper-proof label for various brands, according to the embodiments as disclosed herein;

FIG. 12 are exemplary illustrations of the tamper-proof label, according to the embodiments as disclosed herein;

FIG. 13a, FIG. 13b and FIG. 13c are schematic illustrations of a handheld scanner, according to the embodiments as disclosed herein;

FIG. 14 is a block diagram of a machine in the example form of a computer system within which instructions for causing the machine to perform any one or more of the methodologies discussed herein may be executed; and

FIG. 15 is a block diagram of a machine in the example form of a mobile computing system within which instructions for causing the machine to perform any one or more of the methodologies discussed herein may be executed.

### DETAILED DESCRIPTION OF THE EMBODIMENTS

The above-mentioned needs are met by providing a computer-implemented method and system to secure and verify delivered items during delivery transition. The following detailed description is intended to provide example implementations to one of ordinary skill in the art and is not intended to limit the invention to the explicit disclosure, as one of ordinary skill in the art will understand that variations can be substituted that are within the scope of the invention as described.

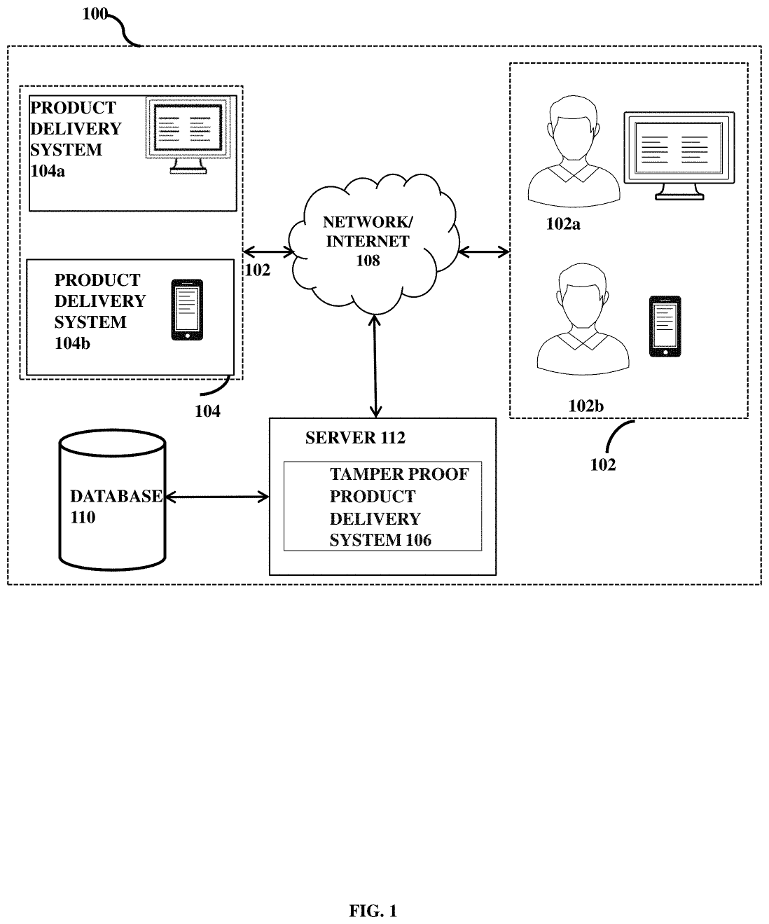

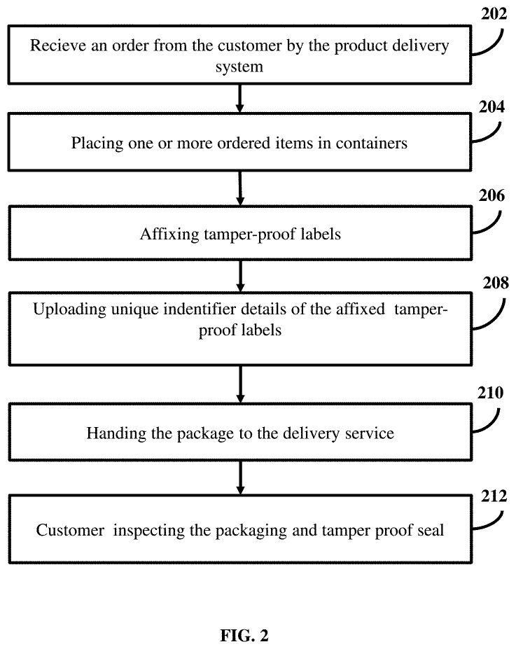

With reference to the diagram in FIG. 1, in an environment diagram 100 of the method, a plurality of customers 102 are represented by customers 102A and 102B, who would like to order products from one or more product delivery system(s) 104 that are delivered to a house, office, or other location that is convenient for them to receive the ordered product. According to certain embodiments, the product delivery system may also be the product sources or sellers or merchants that integrate with third-party delivery services to deliver the ordered products to the customers. While only two customers are shown, they are representative of a whole group of potential customers 102. They can choose from any one of many product delivery system(s) 104, represented by 104A and 104B. While only two product delivery systems are shown, they represent all product delivery systems 104 from which customers 102 can order one or more products. Generally, product delivery systems 104 include any business that packages its own products, usually by hand and on a small scale, and that offers food for sale to customers 102 who want it delivered to them by delivery service.

According to the disclosed method, the tamper-proof product packaging system 106 establishes a computer-enabled platform and implements the processes and procedures in association with the product delivery system(s) 104 ensuring to provide independent validation of the product packaging for the product(s) delivered to the customer by the product delivery system(s) 104.

The platform established by the tamper-proof product packaging system 106 comprises both hardware and software, for the computer-implementation of the system and the hub of the tamper-proof product packaging system 106 is one or more servers 112 that host a website that acts as a portal for access to the system operated by tamper-proof product packaging system 106. One or more servers 112 comprise one or more processors, memory on which is stored a set of instructions and digital database 110. System users include a plurality of product delivery systems 104, a plurality of customers, represented by customer 102 connected through a network 108. There can be different variations of the disclosed platform, but with each platform, tamper-proof product packaging system 106 is responsible for the processes and systems that are used by the method to assure customers that orders are delivered tamper-proof. Accordingly, tamper-proof product packaging system 106 provides the user interface programs that are used by the users, of which an exemplary embodiment can be product delivery systems 104 and customer 102. The user interface can include features for helping with inventory records. A scanner or camera that is used to enter unique identifiers, or a similar device can also be used to upload the details of the tamper-proof labels.

In preferred applications of each embodiment, all scans, data entries, notifications and other communications within the platform, between the user interfaces and the tamper-proof product packaging system 106 are all date and time stamped, and a location stamp can also be enabled for when the package is out for delivery or being delivered.

According to an embodiment, the tamper-proof product packaging system 106 has an inventory of supplies that can comprise secure packaging and tamper-proof labels with unique identifiers associated therewith. The unique identifiers can be marked directly or printed on tamper-proof seal labels.

Once, the product delivery system 104 packages an order in the secure packaging with the tamper-proof label with the unique identifier, it is then associated with the packaged product in digital database 114. All of the unique identifiers that have been previously used by product delivery system 104 will be marked as “used” in the digital database 112. Initially, all of the unique identifiers are marked as “available” for use and when the product delivery system 104 uploads a unique identifier then it is marked as “used”, which in turn will trigger an automatic alert to instruct the use a different unique identifier for further packaging.

For each order packaged by product delivery system 104, the product delivery system 104 uses product delivery system computing device, which has a user interface for uploading the unique identifier to the server operated by tamper-proof product packaging system 106. The user interface and server 114 can communicate over a communications network 108. When the server 114 receives the unique identifier, the processor follows set of instructions to automatically reference digital database 110 to verify that the unique identifier is assigned to tamper-proof label, and that the unique identifier has not been previously deployed, marked as used, or otherwise invalid. The tamper-proof product packaging system 106 immediately alerts product delivery systems 104, if the unique identifier is invalid, and if the unique identifier is confirmed to be valid the processor confirms and marks the unique identifier as “deployed” in digital database 110. A unique identifier that has been marked as deployed signals to the processor that this unique identifier cannot be approved for use with any other food order.

If the processor determines that a unique identifier is invalid, then the status of the unique identifier is set as invalid and there can be a number of reasons for this. For example, a product delivery systems 104 can report a damaged or spoiled and un-usable tamper-proof labels associated with a unique identifier. This can be common for tamper proof adhesive labels because the tamper proof features of labels can cause it to tear if not used carefully. An invalid status for a unique identifier can be revoked if a product delivery systems 104 later reports that it has found the unique identifiers that were previously reported lost, and then the tamper-proof product packaging system 106 confirms that the invalid status is removed from the digital database 110.

According to an embodiment, the tamper-proof product packaging system 106 may also put its brand or the name on the label to further reinforce that the validation against tampering is provided by an independent third-party that will be accountable to the customer for the accuracy of the security validation. The tamper-proof product packaging system 106 ensures that the tamper proof labels are of a type and quality that will prevent any opening of the product containers from being undetected. Tamper-proof product packaging system 106 tests the tamper-proof seal labels on containers of the same type to be certain that the tamper proof seal packaging cannot be removed or otherwise circumvented by someone without the access or attempted access to the food being visibly apparent. The tamper-proof product packaging system 106 can also provide instructions to the product delivery systems 104 on how to apply the seal labels properly and consistently so that they will be effective in discouraging tampering.

The tamper-proof product packaging system 106 ensures that the customers know that each tamper-proof label has a unique identifier that allows tamper-proof product packaging system 106 to track each product container, and further allows the customer to check that the unique identifier associated with the package that is delivered, matches the unique identifier that was applied to the package when it was sealed by the product delivery system 104. Once the tamper-proof label is applied to the container, the container cannot be opened without verifiable evidence of access that is visible to customer 102. When a unique identifier is combined with a tamper-proof label, customer 102 has an extra level of protection since it is part of the disclosed platform and method for validating to customer 102 that the product being delivered has not been tampered with. If the unique identifier on the tamper proof seal device that seals the delivered container does not match the unique identifier that was assigned when the product was packaged, then the customer 102 will know that the container being delivered is the wrong container, or that it has been opened, with someone replacing the original tamper-proof label with another tamper-proof label, possibly a counterfeit one, even if there is no visible damage to the replacement tamper-proof label. The customer 102 will also know that as part of the process agreed to by product delivery systems 104, the tamper proof seal devices will be applied to the containers before the containers are handed over to the one delivering the container for delivery service.

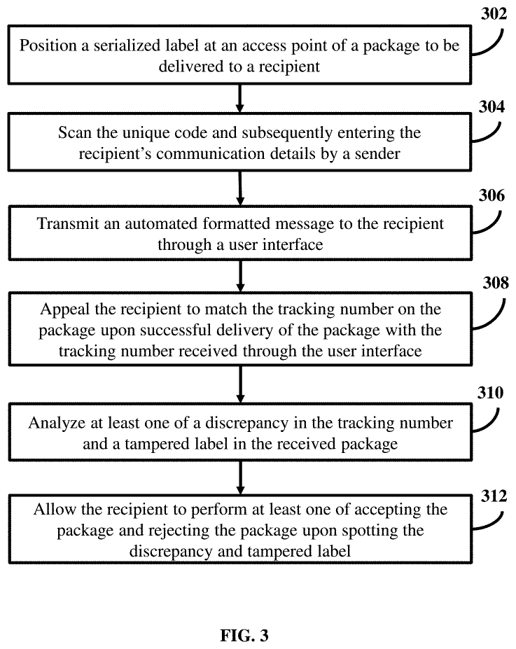

With reference to FIG. 2, which illustrates the steps of the process, in step 202 a product delivery system 104 receives an order from the customer for one or more products, and in step 204 it prepares or picks the products ordered by the customer and puts it into one or more containers. Once the items are packaged, in step 206 a representative of the product delivery system 104 affixes the tamper-proof labels with the unique identifier as a seal on the packaging.

In certain cases, only one tamper-proof seal label may be necessary, for example if only one item is ordered, and it is packaged in one container, or if a plurality of containers is packaged inside a larger container such as a box or bag. In other cases, because of the way the items are packaged, it may be necessary to apply more than one tamper proof seal labels, for example if there are drinks packaged in a separate food container from food items, or if it is a large food order and the items cannot fit into one food container.

In step 208 the unique identifiers on the tamper proof seal label(s) applied to the container(s) are uploaded to a tamper-proof product packaging system 100 database 110, for example in FIG. 1. Certain information associated with the order that will help with tracking can also be uploaded at the same time, such as the customer's name and address, the products ordered etc., through the user interfaces provided by the tamper-proof product packaging system 106. Some of the information that is uploaded can be customized to include only those that are relevant to the type of product delivery systems 104. To facilitate this step, the unique identifier can be machine readable, and the product delivery system's user interface that is provided by the tamper-proof product packaging system 106 as part of the disclosed platform, can be programmed with the capability to enter the unique identifier into the product delivery computing device, using, for example a scanner or a camera. The unique identifier can be, for example, without limitation, a simple code comprising letters, numbers and keyboard symbols (enabling the code to be manually entered using a mechanical or electronic keyboard), a bar code, or a QR code. It is important that step 208 is done before step 210, which is when a representative of product delivery systems 104 hands the container(s) over to the delivery service.

Once the customer receives the container(s), in method step 212, the customer can inspect the packaging and tamper-proof seal device to ensure that it is intact and not damaged. In this step, in a preferred embodiment, because the unique identifier was uploaded by the product delivery systems 104, the customer can access the tamper-proof product packaging system 106 database 110, for example in FIG. 1, to check that the unique identifier matches what is saved in the digital database 110 as the unique identifier that was marked in the digital database as being deployed by the product delivery systems 104 for the delivered order. Alternatively, the customer can contact the product delivery systems 104 to confirm that the unique identifier on the received container matches the unique identifier assigned by the systems. This confirms that the correct containers have been delivered and that the tamper-proof label was not replaced with a different one.

In an alternative embodiment, in step 208 when the product delivery systems 104 uploads the data to the tamper-proof product packaging system 106, a notification can also be sent to the customer 102 with the unique identifier, for example by a text notification, e-mail, phone call or other notification method chosen by the customer. In some embodiments, the notification can include the time when the order was packaged and sealed, and an estimated delivery time.

According to an embodiment, the tamper-proof product delivering system transmits the tamper-proof label details associated with package to the customer 102 through the customer user interface provided by a mobile or web-based applications installed and accessible on the customer computing device. This can be done automatically if the customer 102 has a customer profile saved with the tamper-proof product packaging system so that the customer's identity is known and verified. In another embodiment the customer can communicate with the one or more servers to retrieve the unique identifier of the tamper-proof label by providing information about the product order, or a verification code automatically given to the customer 102 by the product delivery system 104 and/or tamper-proof product packaging system 106 when the customer ordered the product. With these embodiments the customer can immediately validate that the product has been delivered correctly and securely.

When the customer 102 receives the order, customer 102 can inspect the packaging to be sure that it has not been opened by checking for holes in the packaging or visible damage to the tamper proof sealing device. Customer 102 uses customer computing device to communicate with the tamper-proof product packaging system 106 through a communications network such as internet 106, using a customer interface program provided by the tamper-proof product packaging system 106. The customer interface program can be obtained from the tamper-proof product packaging system 106 website or from an “app store” for free or for a nominal fee, as determined by the tamper-proof product packaging system 106. The tamper-proof product packaging system 106 can offer different types of customer interface programs, such as mobile applications for customers that wish to load it onto a smart phone or tablet, or a desktop program for customers that wish to load it onto a desktop computer. If the customer interface program is a mobile application, it can be programmed to give the customer the option to use the camera of the mobile device to scan the unique identifier, or alternatively, to enter the unique identifier manually. The mobile application can also provide a means for the customer to take pictures of the packaging that can be uploaded to server 112 so that the customer can immediately report any damage to the packaging or the tamper-proof label that could indicate tampering.

If the packaging looks intact, customer 102 can use the customer interface program to scan or manually enter the unique identifier, which is then automatically shared with tamper-proof product packaging system 106. Upon receiving the unique identifier, from customer 102, processor checks that it matches with the unique identifier uploaded by the product delivery system 104, which was marked “deployed”. Processor, as directed by set of instructions, automatically checks digital database 110 and compares the unique identifier reported by customer 102 with the unique identifier uploaded by product delivery system 104 and marked as deployed for the received product order. If there is a match, processor confirms to customer 102 that the security of the product order is validated and then the processor makes the unique identifier as “used” in digital database 110.

If there is no match, processor communicates to customer that the security of the product order cannot be validated because the unique identifiers do not match. Processor then marks both of the unique identifiers as used in digital database 110 and also stores in digital database 110 a record of the product order, the two different unique identifiers associated with that order and the time that the delivery was reported by the customer and the time the customer was notified that the security of the delivery could not be validated. In preferred embodiments, a set of instructions also direct processor to communicate a copy of the record to product delivery system 104. If the customer uploads any picture of damaged food packaging or damaged tamper proof seal devices, these pictures are also saved in digital database 110 and shared with the product delivery system. In preferred embodiments, the processor can be instructed to also record performance metrics including the time when the food order was delivered, and any positive or negative comments reported by customers.

In preferred embodiments, the database 110 is cloud-based, meaning that the cloud database is delivered as part of the service provided by the tamper-proof product packaging system 106 to product delivery system 104 and customers 102. The tamper-proof product packaging system 106 manages back-end processes associated with the database installation, deployment, data management and resource assignment tasks. As part of the platform, the tamper-proof product packaging system 106 makes also provide tools to product delivery systems 140, such as a web interface and/or user application for uploading the unique identifier and other data associated with orders. The tamper-proof product packaging system 106 may also make tools available to customers, also as part of the platform, such as a customer application for a smart phone or other device to allow them to communicate with the server to report the unique identifier or access the database and retrieve the unique identifiers associated with their respective orders.

Further, examples of the network 106 include, but are not limited to, wireless network, wire line network, public network such as the Internet, Intranet, private network, General Packet Radio Network (GPRS), Local Area Network (LAN), Wide Area Network (WAN), Metropolitan Area Network (MAN), cellular network, Public Switched Telephone Network (PSTN), personal area network, and the like. The network 116 can be operable with cellular networks, Bluetooth network, Wi-Fi networks, or any other networks or combination thereof.

Variations can be made to the embodiment of the method described in relation to FIG. 1 and FIG.2 without departing from the spirit of the disclosed method concept for example customers makes an order through intermediary business.

It should be appreciated by those of ordinary skill in the art that FIG.1 depicts the computing device in an oversimplified manner and a practical embodiment may include additional components and suitably configured processing logic to support known or conventional operating features that are not described in detail herein.

FIG. 3 is a flow diagram illustrating a method to secure and verify delivered items during delivery transition using the established platform of FIGS. 1 & 2 with the tamper-proof product packaging system 106, according to the embodiments as disclosed herein. The flow diagram begins at step 302.

Delivery is the process of transporting an item/package from a source location to a predefined destination (or from a sender to a customer). The method described herein aims at tracking and identifying tampering of the item during the transition of delivery.

At step 302, a tamper-proof label with unique identifier is positioned at an access point of a package to be delivered to a customer by the product delivery system 104 and the details of the same are cross-checked and updated with the database 110 of the tamper-proof product packaging system 106.

The label is a unique label that is placed and sealed at the opening of a package. The package is a wrap that is used to cover an item for delivery. Examples of the package include, but are not limited to, bottle, box, can, carton, cover, pouch and sack. The opening of the package is herein referred as the “access point” or “seal point”. For instance, on a box, the access point is where the two sides of the flaps meet or on a bag of food, the access point is the opening that is rolled down and later stapled or taped to seal. In some embodiments, several versions of the label are created for packages with unique shapes and properties such as soft drink cups. For such items, tamper-proof tags can be used.

The unique identifier of the tamper-proof label is in machine readable form, whereby it can be entered into the database by being electronically scanned or photographed. If in machine readable form, it can be in a bar code, QR Code or some other coded form. The ink or toner that is used to print the code can be magnetic, for example, by containing iron oxide. In some embodiments, the code can be translated into a format that consists of some or all of n alpha-numeric and/or keyboard symbols so that the code can be communicated by text and entering into a computer manually, without a scanner or camera. A magnetic ink character recognition (MICR) code is an example of a code standard that uses magnetic ink and because these codes are normally numeric, they can be easily read by people and put into a text message or entered manually into a computer using a keyboard. In other embodiments, an application can be installed on the customer's smart phone so that the phone's camera can scan the code and confirm that it is the same code that is associated with the seal label that was applied at the product delivery system to seal the container. Other types of codes and technologies can be substituted to function in substantially the same way to achieve substantially the same result. For example, instead of printing with ink the unique identifier can be laser etched. In yet another example the seal labels can further incorporate radio frequency identification RFID technologies that use electromagnetic fields to automatically identify and track containers.

At step 304, the unique code is scanned and subsequently the customer's communication details are entered by the product delivery system 104 using the user interfaces provided by the tamper-proof product packaging system 106.

Upon scanning, a formatted message is sent to the intended customer 102 through an SMS or an email through the notification methods provided by the tamper-proof product packaging system 106. The information included within the formatted message includes the tracking number, confirmation that the item has been shipped, important contact information and any other customized information the product delivery system would like to provide.

At step 306, an automated formatted message is transmitted to the customer through a user interface provided by the tamper-proof product packaging system 106.

Typically, the formatted message is sent through an SMS or an email to the customer. However, it is to be noted that any other suitable and appropriate communication method may be implemented.

At step 308, the customer is appealed to match the tracking number on the package upon successful delivery of the package with the tracking number received through the user interface provided by the tamper-proof product packaging system 106.

Upon receiving the package/item, the customer is requested to check for discrepancy in the tracking number.

At step 310, at least one of a discrepancy in the tracking number and/or a tampered label is analyzed.

The customer identifies two types of tampering during the transition of the package from the product delivery system. The first kind of tampering involves the discrepancy in the tracking number. A second kind of tampering is self-evident on the label. Torn, broken, missing and detached labels or package damage are primary (visual) indicators of tampering.

At step 312, the customer is allowed to either accept the package or reject the package upon spotting the discrepancy and tampered label.

The method described herein is typically targeted for the food delivery industry. However, in some embodiments, the method may be implemented for prescription medicine, grocery and retail goods.

Although, the original core function was to protect the integrity of the product delivery, the method described herein also has a vast range of other potential uses for prevention of other product tampering such as prescriptions and merchandise.

The flow diagram ends at step 312.

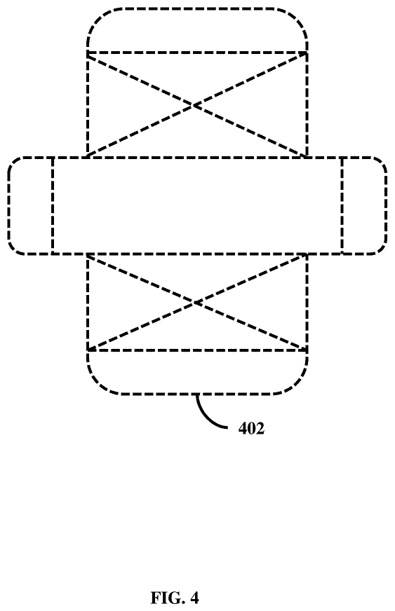

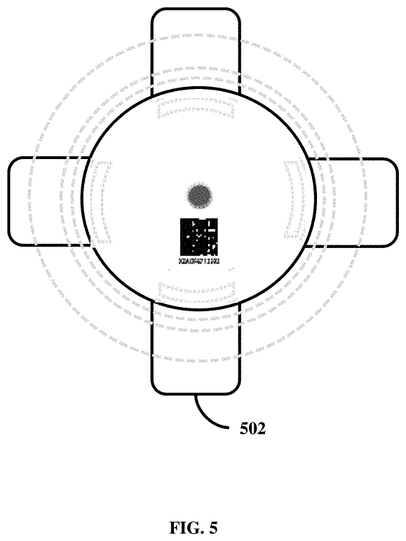

FIG. 4 is a schematic representation illustrating the dimensions and scale of a tamper-proof label, according to the embodiments as disclosed herein. The tamper-proof label 402 illustrates its shape and features. Typically, the tamper-proof label 402 is available in three possible size options “small”, “medium” and “large”. The small size is four inches, medium size is 5 inches and large size is 6 inches approximately.

The tamper-proof label can comprise a paper or plastic sheet label with an adhesive backing with tamper proof features, so that once applied to the packaging, the tamper-proof seal label cannot be removed without tearing, deforming, or some other evidence of damage to the tamper proof seal label. With this embodiment, the unique identifier can be imprinted on the tamper proof seal label, which can then be applied to the packaging at a location that prevents the opening of the packaging without damaging the tamper proof seal label. The tamper-proof label 402 includes a perforated middle tab that allows the customer to break the label seal and access the contents easily. Some labels, employ closing features that use tabs slightly wider than the body the and/or with bar shaped edges that is inserted into the slots and the package cannot be opened without pulling or cutting the tabs.

An examplary scenario, with a unique identifier can be, a Quick Response Code (QR code) or a barcode printed on the tamper-proof label. The barcode holds information only in the horizontal direction. The QR code is a computer-generated pictogram containing data. While the QR code is similar to the barcode, it holds information in a matrix of dots (both in horizontal and vertical directions). It is due to this arrangement that the QR code holds hundreds of times more information than a barcode. The tamper-proof label 402 displays the tracking number below the code. This tracking number is used by the customer of the delivery to identify their order. Further, the Label 402 is designed to work with existing available shipping or delivering products such as clamshells, paper bags, boxes, locking devices and the like.

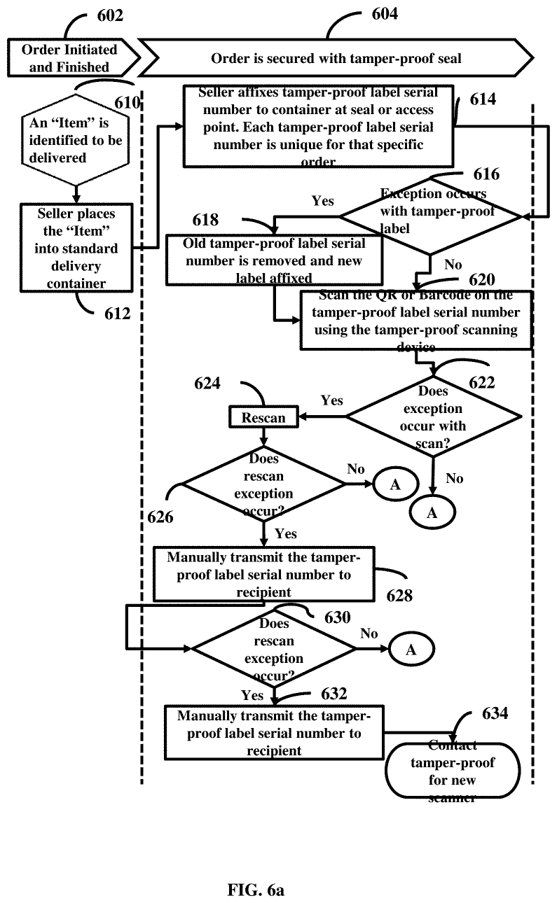

FIG. 5 is a schematic representation of the tamper-proof label for a drink saver, according to the embodiments as disclosed herein. The tamper-proof label described in FIG. 4 is also available in various versions based on the shape and properties of the package, for instance soft drink cups. In such a scenario, a tamper-proof label tag 502 is used as shown in FIG. 5.

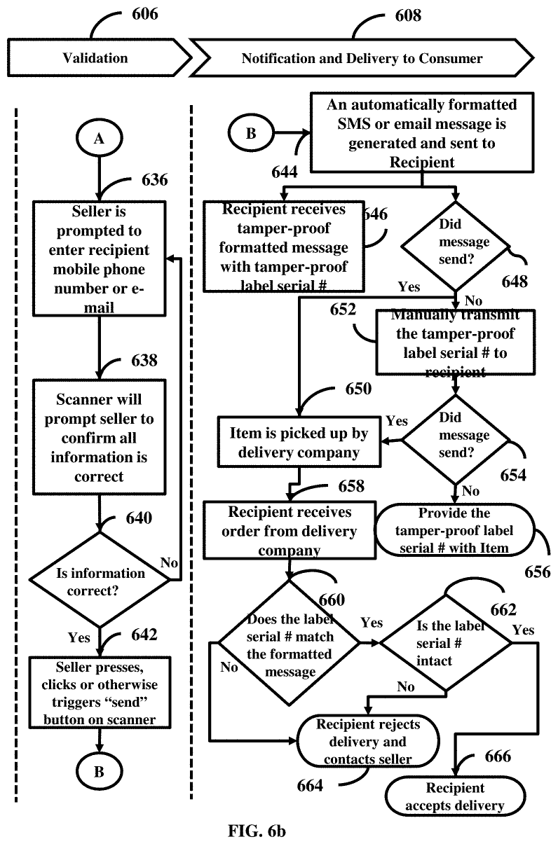

FIG. 6a and FIG. 6b are a sequence diagram illustrating the transition of a package during delivery between the product delivery system and the customer integrated with the tamper-proof package delivery system 106, according to the embodiments as disclosed herein.

The objects involved in this sequence diagram are “Order Initiated and Finished 602”, “Order is secured with tamper-proof label seal 604”, “Validation 606” and “Notification and Delivery to Consumer 608”. The scenario of this diagram is the transition of a package delivery between the sender and the receiver integrated with the tamper-proof package delivery system 106.

To begin with, an “Item” is identified to be delivered 610 by the product delivery system based on the request received from the customer. The item herein refers to a perishable item or a non-perishable item. Examples of the item includes, but is not limited to, food, drinks, medication and blood or blood products. The product delivery system places the item into a standard delivery container 612. The product delivery system(s) herein refers to any person, company, individual or entity that creates develops facilitates the production or procurement of the item being delivered. Consequently, step 610 and step 612 completes the object “Order Initiated and Finished 602” and now the transition of the package delivery moves to the “Order is secured with tamper-proof label seal 604”.

Here, the product delivery system affixes the tamper-proof label with a unique identifier to the container at seal or access point 614 as provided by the tamper-proof packaging system 106. At step 616, if an exception occurs with tamper-proof label serial number then step 618 is performed else step 620 is performed. At step 618, the old tamper-proof label is removed and a new label is placed and subsequently step 620 is performed, and the updates the status of the tamper-proof label at the digital database 110 provided to the customer by the tamper-proof packaging system 106 through the application installed at the customer's computing device. At step 620, the QR code or barcode on the tamper-proof label serial number is scanned using any uploading means such as a scanning device through the user interface provided by the tamper-proof packaging system 106. Consequently, step 622 is performed. At step 622 if an exception occurs upon scanning then, step 624 is performed otherwise the transition moves to “Validation 606”. At step 624, the label is rescanned and subsequently step 626 is performed. At step 626, if rescan exception occurs then, step 628 is performed otherwise the transition moves to “Validation 606”, and the validated details of the tamper-proof label are stored in the digital database 110 of the tamper-proof packaging system 106. At step 628, the tamper-proof label serial number is manually transmitted to the customer through SMS, email, phone or text to the customer by the tamper-proof packaging system 106 through the application installed at the customer's computing device. Subsequently, step 630 is performed. At step 630, if a rescan exception occurs then, step 632 is performed else the transition moves to “Validation 606”. At step 632, the tamper-proof label serial number is manually transmitted to the customer through SMS, email, phone or text to the customer by the tamper-proof packaging system 106 through the application installed at the customer's computing device. At step 634, a scanner is required and appropriates actions are taken to fulfil this. At this point, the transition moves to “Validation 606”.

Now at step 636, the product delivery system is prompted to enter one or more details about the order such that the customer mobile phone number or e-mail through user interfaces provided by the tamper-proof packaging system 106 are displayed at the product delivery system's computing device. At step 638, the scanner will prompt the product delivery system to confirm if all information is correct. At step 640, if the information is correct, step 642 is performed otherwise step 636 is repeated. At step 642, the product delivery system presses click or otherwise triggers “send” button on the scanner. Subsequently, the transition moves to “Notification and Delivery to Consumer 608”.

The “Notification and Delivery to Consumer 608” is the final stage/phase of the delivery transition. At step 644, a formatted message is automatically generated and sent to the customer through an SMS or email message by the tamper-proof packaging system 106 through the application installed at the customer's computing device. At step 646, the customer receives a notification with the unique identifier of the tamper-proof label associated with the packaging. At step 648, if the message was not sent then the unique identifier of the tamper-proof label is manually sent to the customer 652 and subsequently verified for the same at step 654. If the message was still not sent then at step 656 the tamper-proof label serial number with the item is sent. On the other hand, at step 648, if the message was sent successfully then step 650 is performed. At step 650, the item is picked up by the delivery company. At step 658, the customer receives the order from the delivery company. At step 660, the customer checks to see if the label serial number received with the item is matched with the formatted message transmitted by the tamper-proof product packaging system 106. If there is a match, step 662 is performed. At step 662, if the label serial number is intact, then the customer accepts the item delivery. However, if there is a mis-match at step 660 or if the label serial number on the item was not intact at step 662 then the customer rejects the item delivery at step 664. The customer then contacts the product delivery system using the user interface of the application provided by the tamper-proof product packaging system.

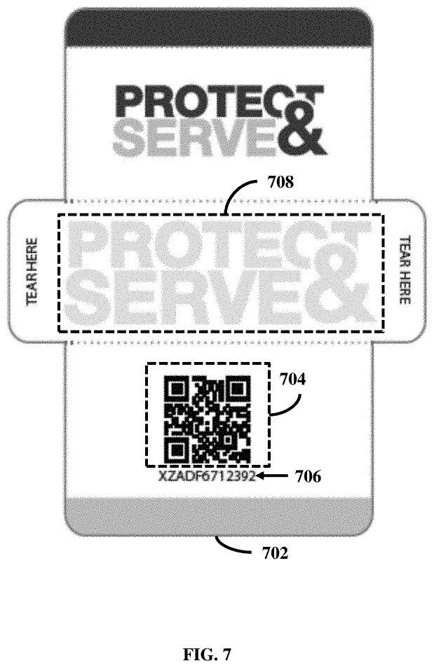

FIG. 7 is a pictorial representation of the tamper-proof label for a default brand, according to the embodiments as disclosed herein.

The tamper-proof label 702 includes the barcode/QR code 704 and the tracking number 706. Further, the tamper-proof label 702 includes the logo 708 in the middle. The logo 708 is typically a thin transparent film with the identity.

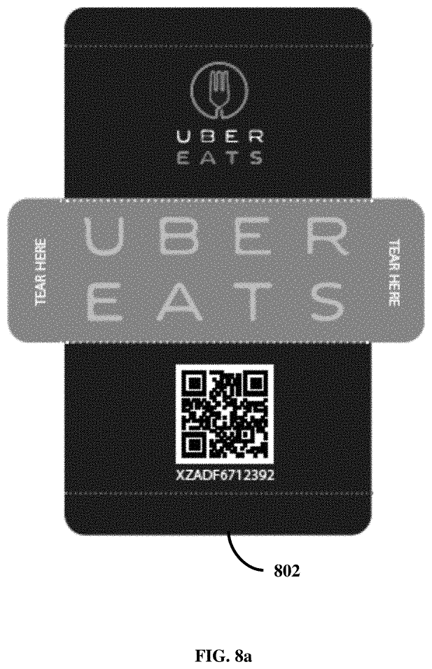

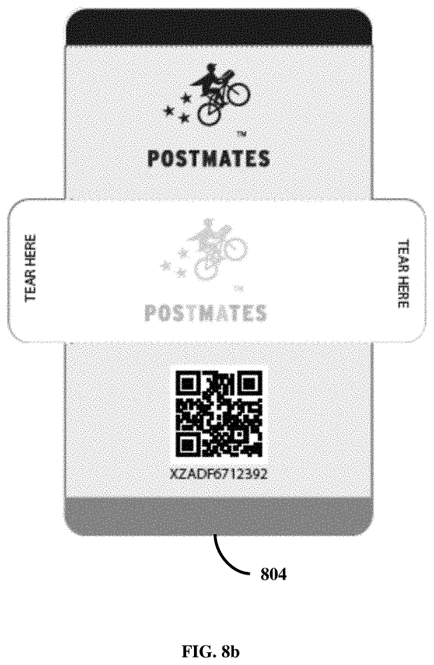

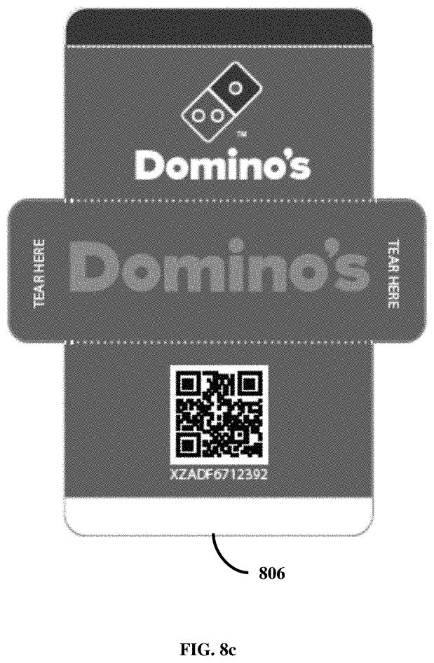

FIG. 8a, FIG. 8b and FIG. 8c are pictorial representations of the tamper-proof label for exemplary brands, according to the embodiments as disclosed herein.

The tamper-proof label for Uber Eats 802, Postmates 804 and Domino's 806 is illustrated in FIG. 8a, FIG. 8b and FIG. 8c respectively.

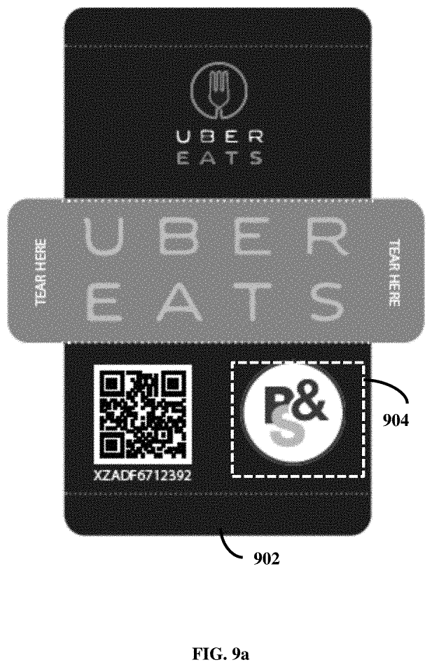

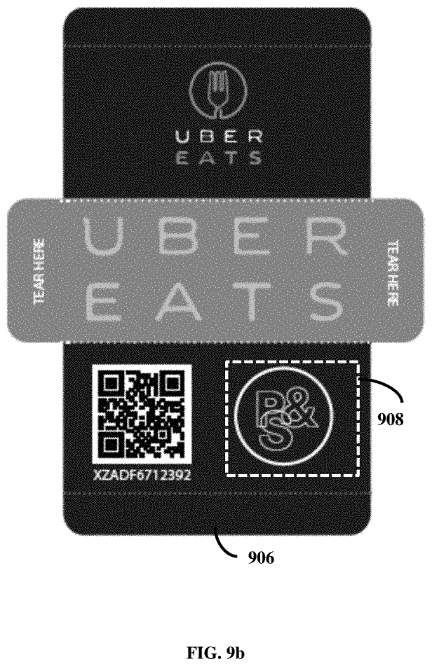

FIG. 9a and FIG. 9b are pictorial representations of the tamper-proof label with a logo mark, according to the embodiments as disclosed herein. The tamper-proof label for Uber Eats 902 includes the tamper-proof logo mark 904 on one of the flaps. Similarly, the tamper-proof label for Uber Eats 906 includes the tamper-proof logo mark 908 in an outline.

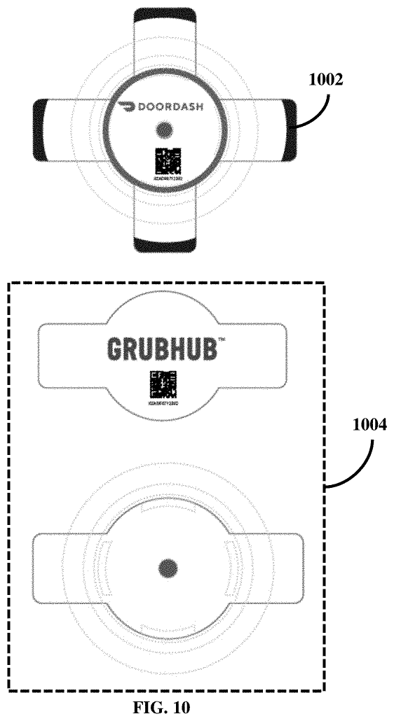

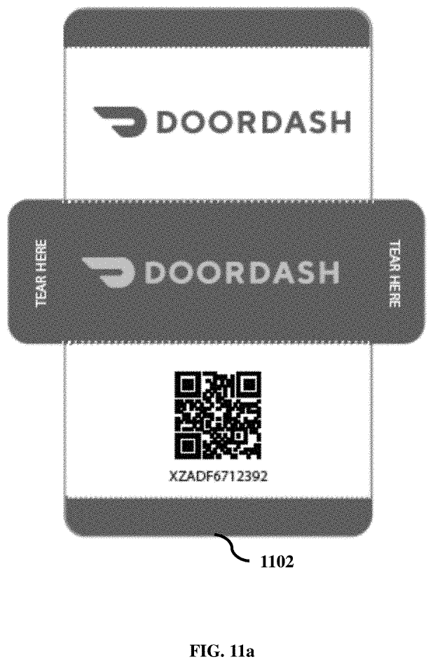

FIG. 10 is a schematic illustrations of the tamper-proof label for drink savers, according to the embodiments as disclosed herein. The illustrations depict two types of tamper-proof labels 1002 and 1004 for drink savers.

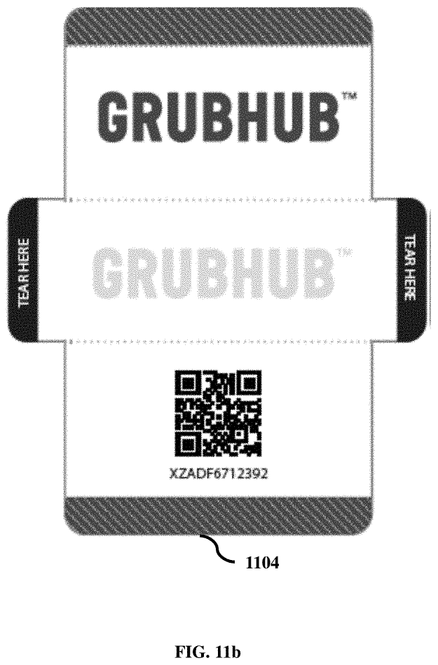

FIG. 11a and FIG. 11b are exemplary representations of the tamper-proof label for various brands, according to the embodiments as disclosed herein. The tamper-proof label 1102 depicts another exemplary brand “Doordash”. The tamper-proof label 1104 depicts a customized label.

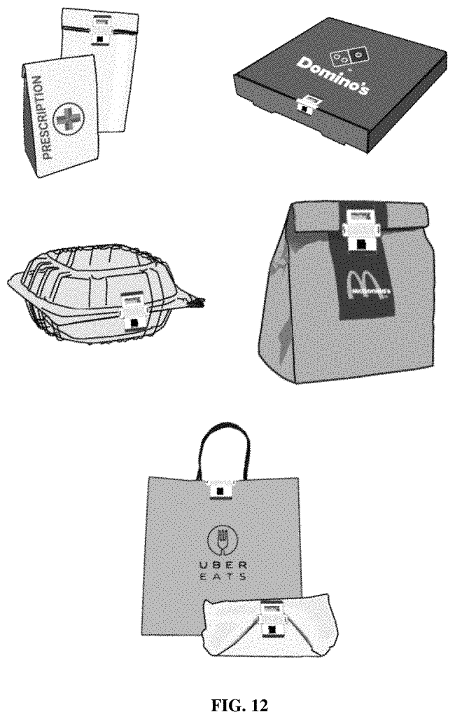

FIG. 12 depicts exemplary illustrations of the tamper-proof label, according to the embodiments as disclosed herein. The illustrations describe forms of placing the tamper-proof labels on various types/nature of packages. For example, the package is a paper or plastic bag into which a plurality of smaller food containers can be deposited. Because the top of the bag is folded over or rolled down, a bag cannot be opened without breaking tamper-proof seal label. In another example, the package is cardboard box that can be used to deliver food, such as pizza. Box has a lid that is attached to the bottom of the box and the lid has a creased edge to that it can be lifted to open the box, the tamper proof seal label is affixed to the edge of the lid that is opposite to the attached edge so that the lid cannot be lifted without breaking the seal. In another example, the packaging can be a “clam shell” style container and once tamper-proof label has been applied, the container cannot be opened without breaking the seal or visibly deforming the container.

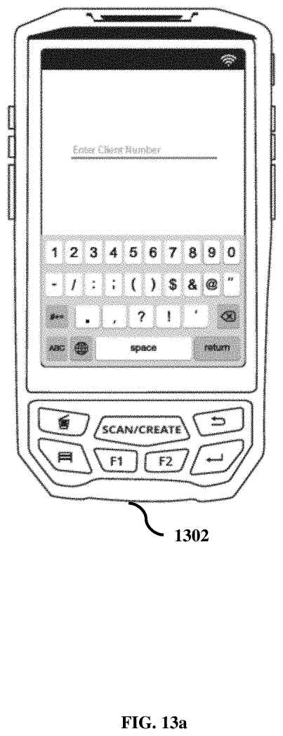

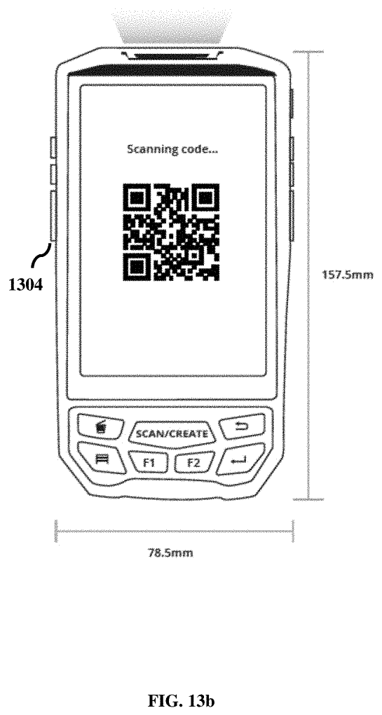

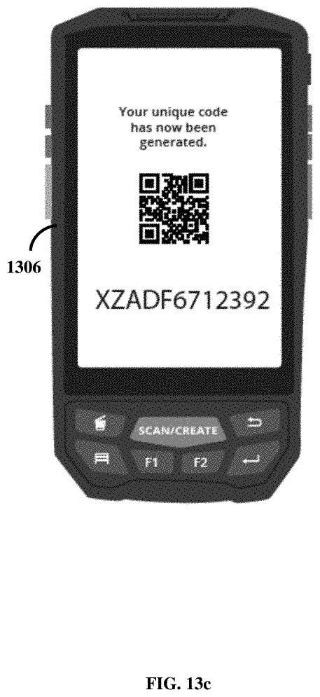

FIG. 13a, FIG. 13b and FIG. 13c are schematic illustrations of a handheld scanner, according to the embodiments as disclosed herein. FIG. 13a illustrates a mobile device with a handheld scanner wherein the product delivery system is allowed to enter the client number on the mobile application 1302. FIG. 13b illustrates the scanning of the barcode/QR code through the scanner 1304. FIG. 13c illustrates the generation of the unique code 1306.

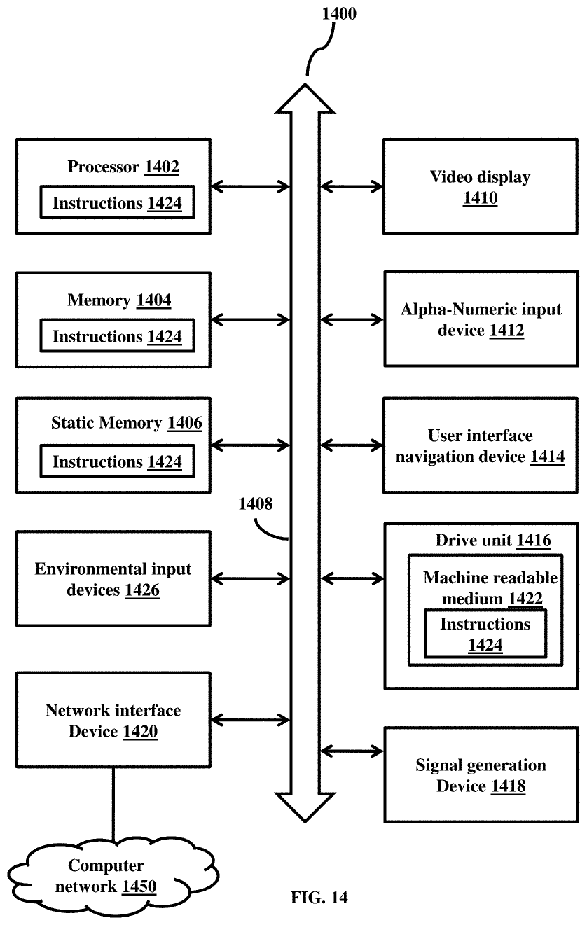

FIG. 14 is a block diagram of a machine in the example form of a computer system within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1400 includes a processor 1402 (e.g., a central processing unit (CPU), a graphics processing unit (GPU), or both), a main memory 1404, and a static memory 1406, which communicate with each other via a bus 1408. The computer system 1400 may further include a video display unit 1410 (e.g., a liquid crystal display (LCD) or a cathode ray tube (CRT)). The computer system 1400 also includes an alphanumeric input device 1412 (e.g., a keyboard), a user interface (UI) navigation device 1414 (e.g., a mouse), a disk drive unit 1416, a signal generation device 1418(e.g., a speaker), and a network interface device 1420. The computer system 1400 may also include an environmental input device 1426 that may provide a number of inputs describing the environment in which the computer system 1400 or another device exists, including, but not limited to, any of a Global Positioning Sensing (GPS) receiver, a temperature sensor, a light sensor, a still photo or video camera, an audio sensor (e.g., a microphone), a velocity sensor, a gyroscope, an accelerometer, and a compass.

The disk drive unit 1416 includes a machine-readable medium 1422 on which is stored one or more sets of data structures and instructions 1424 (e.g., software) embodying or utilized by any one or more of the methodologies or functions described herein. The instructions 1424 may also reside, completely or at least partially, within the main memory 1404 and/or within the processor 1402 during execution thereof by the computer system 1400, the main memory 1404 and the processor 1402 also constituting machine-readable media.

While the machine-readable medium 1422 is shown in an example embodiment to be a single medium, the term “machine-readable medium” may include a single medium or multiple medium (e.g., a centralized or distributed database, and/or associated caches and servers) that store the one or more instructions 1424 or data structures. The term “non-transitory machine-readable medium” shall also be taken to include any tangible medium that is capable of storing, encoding, or carrying instructions for execution by the machine and that cause the machine to perform any one or more of the methodologies of the present subject matter, or that is capable of storing, encoding, or carrying data structures utilized by or associated with such instructions. The term “non-transitory machine-readable medium” shall accordingly be taken to include, but not be limited to, solid-state memories, and optical and magnetic media. Specific examples of non-transitory machine-readable media include, but are not limited to, non-volatile memory, including by way of example, semiconductor memory devices (e.g., Erasable Programmable Read-Only Memory (EPROM), Electrically Erasable Programmable Read-Only Memory (EEPROM), and flash memory devices), magnetic disks such as internal hard disks and removable disks, magneto-optical disks, and CD-ROM and DVD-ROM disks.

The instructions 1424 may further be transmitted or received over a computer network 1450 using a transmission medium. The instructions 1424 may be transmitted using the network interface device 1420 and any one of a number of well-known transfer protocols (e.g., HTTP). Examples of communication networks include a local area network (LAN), a wide area network (WAN), the Internet, mobile telephone networks, Plain Old Telephone Service (POTS) networks, and wireless data networks (e.g., WiFi and WiMAX networks). The term “transmission medium” shall be taken to include any intangible medium that is capable of storing, encoding, or carrying instructions for execution by the machine, and includes digital or analog communications signals or other intangible media to facilitate communication of such software.

As described herein, computer software products can be written in any of various suitable programming languages, such as C, C++, C#, Pascal, Fortran, Perl, Matlab (from MathWorks), SAS, SPSS, JavaScript, AJAX, Java, Swift and Objective C. The computer software product can be an independent application with data input and data display modules. Alternatively, the computer software products can be classes that can be instantiated as distributed objects. The computer software products can also be component software, for example Java Beans or Enterprise Java Beans. Much functionality described herein can be implemented in computer software, computer hardware, or a combination.

Furthermore, a computer that is running the previously mentioned computer software can be connected to a network and can interface to other computers using the network. The network can be an intranet, internet, or the Internet, among others. The network can be a wired network (for example, using copper), telephone network, packet network, an optical network (for example, using optical fiber), or a wireless network, or a combination of such networks. For example, data and other information can be passed between the computer and components (or steps) of a system using a wireless network based on a protocol, for example Wi-Fi (IEEE standard 802.11 including its substandards a, b, e, g, h, i, n, et al. .) In one example, signals from the computer can be transferred, at least in part, wirelessly to components or other computers.

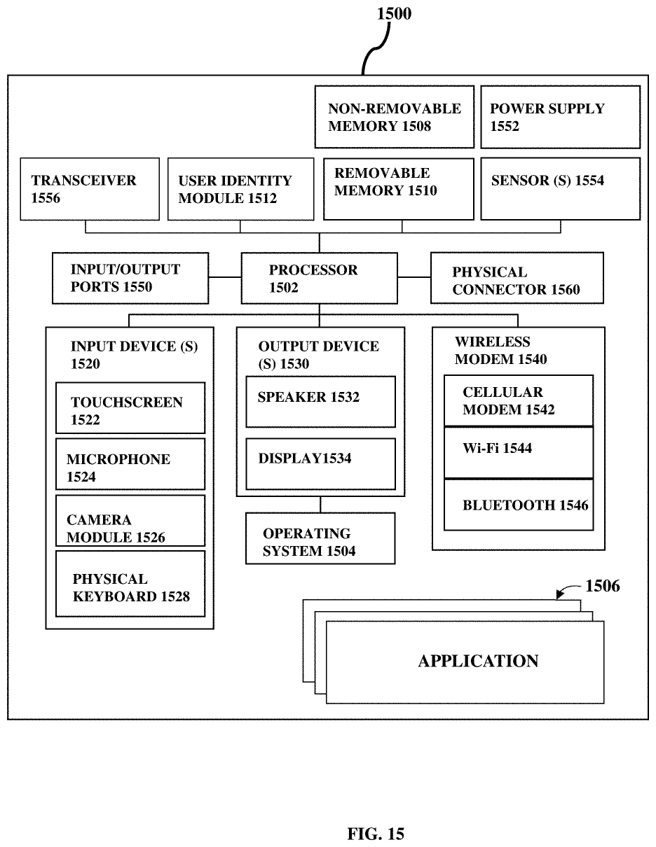

FIG. 15 shows a simplified block diagram of an electronic mobile device 1500 capable of implementing the various embodiments of the present disclosure. The electronic device 1500 may be an example of the mobile electronic devices operated by customer 102b and product delivery system 104b . It should be understood that the electronic device 1500 as illustrated and hereinafter described is merely illustrative of one type of device and should not be taken to limit the scope of the embodiments. As such, it should be appreciated that at least some of the components described below in connection with the electronic device 1500 may be optional and thus in an example embodiment may include more, less or different components than those described in connection with the example embodiment of the FIG. 15. As such, among other examples, the electronic device 1500 could be any of an electronic device or may be embodied in any of the electronic devices, for example, cellular phones, tablet computers, laptops, mobile computers, personal digital assistants (PDAs), mobile televisions, mobile digital assistants, or any combination of the aforementioned, and other types of communication or multimedia devices.

The illustrated electronic device 1500 includes a controller or a processor 1502 (e.g., a signal processor, microprocessor, ASIC, or other control and processing logic circuitry) for performing such tasks as signal coding, data processing, image processing, input/output processing, power control, and/or other functions. An operating system 1504 controls the allocation and usage of the components of the electronic device 1500 and provides support for one or more programs that implement one or more of the innovative features described herein. The applications 1506 may include common mobile computing applications (e.g., telephony applications, email applications, calendars, contact managers, web browsers, messaging applications such as USSD messaging or SMS messaging or SIM Tool Kit (STK) application) or any other computing application.

The illustrated electronic device 1500 includes one or more memory components, for example, a non-removable memory 1508 and/or a removable memory 1510. The non-removable memory 1508 and/or the removable memory 1510 may be collectively known as storage device/module in an embodiment. The non-removable memory 1508 can include RAM, ROM, flash memory, a hard disk, or other well-known memory storage technologies. The removable memory 1510 can include flash memory, smart cards, or a Subscriber Identity Module (SIM). The one or more memory components can be used for storing data and/or code for running the operating system 1504. The electronic device 1500 may further include a user identity module (UIM) 1512. The UIM 1512 may be a memory device having a processor built in. The UIM 1512 may include, for example, a subscriber identity module (SIM), a universal integrated circuit card (UICC), a universal subscriber identity module (USIM), a removable user identity module (R-UIM), or any other smart card. The UIM 1512 typically stores information elements related to a mobile subscriber. The UIM 1512 in form of the SIM card is well known in Global System for Mobile (GSM) communication systems, Code Division Multiple Access (CDMA) systems, or with third-generation (3G) wireless communication protocols such as Universal Mobile Telecommunications System (UMTS), CDMA9000, wideband CDMA (WCDMA) and time division-synchronous CDMA (TD-SCDMA), or with fourth-generation (4G) wireless communication protocols such as LTE (Long-Term Evolution).

The electronic device 1500 can support one or more input devices 1520 and one or more output devices 1530. Examples of the input devices 1520 may include, but are not limited to, a touch screen/a display screen 1522 (e.g., capable of capturing finger tap inputs, finger gesture inputs, multi-finger tap inputs, multi-finger gesture inputs, or keystroke inputs from a virtual keyboard or keypad), a microphone 1524 (e.g., capable of capturing voice input), a camera module 1526 (e.g., capable of capturing still picture images and/or video images) and a physical keyboard 1528. Examples of the output devices 1530 may include, but are not limited, to a speaker 1532 and a display 1534. Other possible output devices can include piezoelectric or other haptic output devices. Some devices can serve more than one input/output function. For example, the touch screen 1522 and the display 1534 can be combined into a single input/output device.

A wireless modem 1540 can be coupled to one or more antennas (not shown in the FIG. 15) and can support two-way communications between the processor 1502 and external devices, as is well understood in the art. The wireless modem 1540 is shown generically and can include, for example, a cellular modem 1542 for communicating at long range with the mobile communication network, a Wi-Fi compatible modem 1544 for communicating at short range with an external Bluetooth-equipped device or a local wireless data network or router, and/or a Bluetooth-compatible modem 1546. The wireless modem 1540 is typically configured for communication with one or more cellular networks, such as a GSM network for data and voice communications within a single cellular network, between cellular networks, or between the electronic device 1500 and a public switched telephone network (PSTN).

The electronic device 1500 can further include one or more input/output ports 1550, a power supply 1552, one or more sensors 1554 for example, an accelerometer, a gyroscope, a compass, or an infrared proximity sensor for detecting the orientation or motion of the electronic device 1500, a transceiver 1556 (for wirelessly transmitting analog or digital signals) and/or a physical connector 1560, which can be a USB port, IEEE 1294 (FireWire) port, and/or RS-232 port. The illustrated components are not required or all-inclusive, as any of the components shown can be deleted and other components can be added.

The disclosed systems and methods with reference to FIGS. 1 to 15, or one or more operations of the method and the flow diagrams may be implemented using software including computer-executable instructions stored on one or more computer-readable media (e.g., non-transitory computer-readable media, such as one or more optical media discs, volatile memory components (e.g., DRAM or SRAM), or non-volatile memory or storage components (e.g., hard drives or solid-state non-volatile memory components, such as Flash memory components) and executed on a computer (e.g., any suitable computer, such as a laptop computer, net book, Web book, tablet computing device, smart phone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such suitable communication means includes, for example, the Internet, the World Wide Web, an intranet, software applications, cable (including fiber optic cable), magnetic communications, electromagnetic communications (including RF, microwave, and infrared communications), electronic communications, or other such communication means.

It is to be understood that although various components are illustrated herein as separate entities, each illustrated component represents a collection of functionalities which can be implemented as software, hardware, firmware or any combination of these. Where a component is implemented as software, it can be implemented as a standalone program, but can also be implemented in other ways, for example as part of a larger program, as a plurality of separate programs, as a kernel loadable module, as one or more device drivers or as one or more statically or dynamically linked libraries.

As will be understood by those familiar with the art, the invention may be embodied in other specific forms without departing from the spirit or essential characteristics thereof. Likewise, the particular naming and division of the portions, modules, agents, managers, components, functions, procedures, actions, layers, features, attributes, methodologies and other aspects are not mandatory or significant, and the mechanisms that implement the invention or its features may have different names, divisions and/or formats.

Furthermore, as will be apparent to one of ordinary skill in the relevant art, the portions, modules, agents, managers, components, functions, procedures, actions, layers, features, attributes, methodologies and other aspects of the invention can be implemented as software, hardware, firmware or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment.

Furthermore, it will be readily apparent to those of ordinary skill in the relevant art that where the present invention is implemented in whole or in part in software, the software components thereof can be stored on computer readable media as computer program products. Any form of computer readable medium can be used in this context, such as magnetic or optical storage media. Additionally, software portions of the present invention can be instantiated (for example as object code or executable images) within the memory of any programmable computing device.

Accordingly, the disclosure of the present invention is intended to be illustrative, but not limiting, of the scope of the invention, which is set forth in the following claims.

What is claimed is:

1. A computer-implemented method for a tamper-proof product packaging system to operate one or more servers to provide tamper-proof delivery of one or more products to a customer from a product delivery system, the method comprising:
receiving a product order for delivery by the customer to the product delivery system; packing the product with tamper-proof label by the product delivery system provided by the tamper-proof product packaging system;
uploading the details of the tamper-proof label by the product delivery system; storing the uploaded tamper-proof label details to a database of the tamper-proof product packaging system;
notifying to the customer the tamper-proof label details by the tamper-proof product packaging system; and
validating and comparing the tamper-proof label details on the delivered package and the received notification by the customer.

2. The computer-implemented method of claim 1, further comprising, the tamper-proof labels with machine readable unique identifiers.

3. The computer-implemented method of claim 1, further comprising, a scanner or camera to upload the details of the tamper-proof labels.

4. The computer-implemented method of claim 1, further comprising affixing the tamper-proof labels with the unique identifier as a seal on the packaging.

5. The computer-implemented method of claim 2, further comprising, unique identifiers of the tamper-proof label as a simple code comprising letters, numbers and keyboard symbols, a bar code, or a QR code.

6. The computer-implemented method of claim 2, further comprising, unique identifiers be marked directly or printed on tamper proof seal labels.

7. The computer-implemented method of claim 1, further comprising, marking the unused tamper-proof labels as available and used tamper-proof labels as used in the database.

8. The computer-implemented method of claim 1, further comprising, a notification sent to the customer with the unique identifier, through an e-mail, phone call, SMS or other notification method chosen by the customer.

9. The computer-implemented method of claim 1, further comprising the notification with the time when the order was packaged and sealed, and an estimated delivery time.

10. The computer-implemented method of claim 1, further comprising, the tamper-proof product packaging system with inventory of supplies that can comprise secure packaging and tamper-proof labels with unique identifiers.

11. A computer-implemented platform for a tamper-proof product packaging system to operate one or more servers to provide tamper-proof delivery of one or more products to a customer from a product delivery system, the method comprising:
receiving a product order for delivery by the customer to the product delivery system; packing the product with tamper-proof label by the product delivery system provided by the tamper-proof product packaging system;
uploading the details of the tamper-proof label by the product delivery system; storing the uploaded tamper-proof label details to a database of the tamper-proof product packaging system;
notifying to the customer the tamper-proof label details by the tamper-proof product packaging system; and
validating and comparing the tamper-proof label details on the delivered package and the received notification by the customer.

12. The computer-implemented platform of claim 11, further comprising, the tamper-proof labels with machine readable unique identifiers.

13. The computer-implemented platform of claim 11, further comprising, a scanner or camera to upload the details of the tamper-proof labels.

14. The computer-implemented platform of claim 11, further comprising affixing the tamper-proof labels with the unique identifier as a seal on the packaging.

15. The computer-implemented platform of claim 12, further comprising, unique identifiers of the tamper-proof label as a simple code comprising letters, numbers and keyboard symbols, a bar code, or a QR code.

16. The computer-implemented platform of claim 12, further comprising, unique identifiers be marked directly or printed on tamper proof seal labels.

17. The computer-implemented platform of claim 11, further comprising, marking the unused tamper-proof labels as available and used tamper-proof labels as used in the database.

18. The computer-implemented platform of claim 11, further comprising, a notification sent to the customer with the unique identifier, through an e-mail, phone call, SMS or other notification method chosen by the customer.

19. The computer-implemented platform of claim 11, further comprising, the notification with the time when the order was packaged and sealed, and an estimated delivery time.

20. The computer-implemented platform of claim 11, further comprising, the tamper-proof product packaging system with inventory of supplies that can comprise secure packaging and tamper-proof labels with unique identifiers.
